(19) United States
(12) Patent Application Publication
(10) Pub. No.: US 2026/0178738 A1
(43) Pub. Date: Jun. 25, 2026

(54) ELECTRONIC DEVICE, METHOD, AND NON-TRANSITORY COMPUTER READABLE STORAGE MEDIUM TO RESTORE STATE OF FIRMWARE PROGRAM

(71) Applicant: Samsung Electronics Co., Ltd., Suwon-si (KR)

(72) Inventors: Seunghwan KIM, Suwon-si (KR); Minkwang LEE, Suwon-si (KR); Yongbum HA, Suwon-si (KR)

(21) Appl. No.: 19/357,544

(22) Filed: Oct. 14, 2025

Related U.S. Application Data
(63) Continuation of application No. PCT/KR2025/015886, filed on Oct. 2, 2025.

(30) Foreign Application Priority Data
Dec. 23, 2024 (KR) 10-2024-0194233
Feb. 20, 2025 (KR) 10-2025-0022480
Mar. 12, 2025 (KR) 10-2025-0032203

(51) Int. Cl. G06F 21/57; G06F 21/55

(52) U.S. Cl. CPC G06F 21/572; G06F 21/554

(57) ABSTRACT

An electronic device includes a main circuit board, integrated circuitry, mounted on the main circuit board, at least one first processor, a second processor, first non-volatile memory, second non-volatile memory, and control circuitry, the at least one first processor is configured to, based on a start of a booting-up of the electronic device, execute a first firmware program, identify, using the first firmware program, a state of a second firmware program that is executed by the second processor, and based on the state of the second firmware program being identified as an abnormal state, transmit, to the control circuitry, a command. And wherein the control circuitry is configured to, based on the command, obtain, from the second non-volatile memory, a backup version of the second firmware program which was backed up when the state of the second firmware program is identified as a normal state, and replace, with the backup version, at least a portion of the second firmware program stored in the first non-volatile memory.

### CROSS-REFERENCE TO RELATED APPLICATION(S)

This application is a continuation application, claiming priority under 35 U.S.C. § 365(c), of an International application No. PCT/KR2025/015886, filed on October 2, 2025, which is based on and claims the benefit of a Korean patent application number 10-2024-0194233, filed on December 23, 2024, in the Korean Intellectual Property Office, and of a Korean patent application number 10-2025-0022480, filed on February 20, 2025, in the Korean Intellectual Property Office, and of a Korean patent application number 10-2025-0032203, filed on March 12, 2025, in the Korean Intellectual Property Office, the disclosure of each of which is incorporated by reference herein in its entirety.

### TECHNICAL FIELD

The disclosure relates to an electronic device, a method, and a non-transitory computer readable storage medium to restore a state of a firmware program.

### BACKGROUND ART

An electronic device may store a first firmware program file for performing a booting-up of the electronic device and a second firmware program file related to a secure function of the electronic device in memory. A second firmware program may be used to assist a first firmware program. The second firmware program may be used to manage a processor used to execute the first firmware. The electronic device may execute an operating system based on executing the first firmware program and the second firmware program.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer readable storage medium to restore a state of a firmware program.

Additional aspects will be set forth in part in the description which follows and, in part, will be apparent from the description, or may be learned by practice of the presented embodiments.

An electronic device is described. The electronic device may comprise a main circuit board. The electronic device may comprise integrated circuitry, disposed on the main circuit board. The integrated circuitry may comprise at least one first processor, and a second processor. The electronic device may comprise a first non-volatile memory, mounted on the main circuit board, comprising one or more storage media. The one or more storage media may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The electronic device may comprise a second non-volatile memory, mounted on the main circuit board, comprising one or more storage media. The electronic device may comprise control circuitry, mounted on the main circuit board, electrically connected to the at least one first processor, the first non-volatile memory, and the second non-volatile memory. The at least one first processor may be configured to, based on a start of the booting-up of the electronic device, execute the first firmware program. The at least one first processor may be configured to identify, using the first firmware program, a state of the second firmware program that is executed by the second processor based on the start of the booting-up of the electronic device. The at least one first processor may be configured to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

An electronic device is described. The electronic device may comprise a main circuit board. The electronic device may comprise integrated circuitry, disposed on the main circuit board. The integrated circuitry may comprise at least one first processor, and a second processor. The electronic device may comprise a first non-volatile memory, mounted on the main circuit board, comprising one or more storage media. The one or more storage media may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The electronic device may comprise a second non-volatile memory, mounted on the main circuit board, comprising one or more storage media. The electronic device may comprise control circuitry, mounted on the main circuit board, electrically connected to the at least one first processor, the first non-volatile memory, and the second non-volatile memory. The at least one first processor may be configured to, based on a start of a booting-up of the electronic device, execute the first firmware program. The at least one first processor may be configured to identify, using the first firmware program, a state of the second firmware program that is executed by the second processor based on the start of the booting-up of the electronic device. The at least one first processor may be configured to, based on the state of the second firmware program being identified as a normal state, transmit, to the control circuitry, a command. The control circuitry may be configured to, based on the command received from the at least one first processor, obtain, from the first non-volatile memory, a backup version of the second firmware program being identified as the normal state. The control circuitry may be configured to store, in the second non-volatile memory, the backup version to be used to restore a state of the second firmware program which will be identified as an abnormal state to the normal state.

An electronic device is described. The electronic device may comprise a main circuit board. The electronic device may comprise integrated circuitry, disposed on the main circuit board. The integrated circuitry may comprise at least one first processor, and a second processor. The electronic device may comprise a first non-volatile memory, mounted on the main circuit board, comprising one or more storage media. The one or more storage media may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The electronic device may comprise a second non-volatile memory, mounted on the main circuit board, comprising one or more storage media. The electronic device may comprise control circuitry, mounted on the main circuit board, electrically connected to the at least one first processor, the first non-volatile memory, and the second non-volatile memory. The first firmware program may include instructions to cause the electronic device to, based on a start of the booting-up, execute the first firmware program. The first firmware program may include instructions to cause the electronic device to identify, using the first firmware program, a state of the second firmware program that is executed by the second processor based on the start of the booting-up of the electronic device. The first firmware program may include instructions to cause the electronic device to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

A method is provided. The method may be executed in an electronic device having a main circuit board, integrated circuitry, mounted on the main circuit board, a first non-volatile memory, mounted on the main circuit board, comprising one or more storage media, a second non-volatile memory, mounted on the main circuit board, comprising one or more storage media, and control circuitry, mounted on the main circuit board, electrically connected to the at least one first processor, the first non-volatile memory, and the second non-volatile memory. The integrated circuitry may comprise at least one first processor and a second processor. The one or more storage media included in the first non-volatile memory may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The method may comprise, based on a start of the booting-up of the electronic device, executing the first firmware program. The method may comprise identifying, using the first firmware program, a state of the second firmware program that is executed by the second processor based on the start of the booting-up of the electronic device. The method may comprise, based on the state of the second firmware program being identified as an abnormal state, transmitting, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

A non-transitory computer readable storage medium is provided. The non-transitory computer readable storage medium may comprise one or more programs. The one or more programs may be executed by an electronic device having a main circuit board, integrated circuitry, mounted on the main circuit board, a first non-volatile memory, mounted on the main circuit board, comprising one or more storage media, a second non-volatile memory, mounted on the main circuit board, comprising one or more storage media, and control circuitry, mounted on the main circuit board, electrically connected to the at least one first processor, the first non-volatile memory, and the non-volatile second memory. The integrated circuitry may comprise at least one first processor and a second processor. The one or more storage media included in the first non-volatile memory may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The one or more programs may include instructions, when executed by the electronic device, that cause the electronic device to, based on a start of the booting-up of the electronic device, execute the first firmware program. The one or more programs may include instructions, when executed by the electronic device, that cause the electronic device to, identify, using the first firmware program, a state of the second firmware program that is executed by the second processor based on the start of the booting-up of the electronic device. The one or more programs may include instructions, when executed by the electronic device, that cause the electronic device to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device including memory storing firmware program files according to an embodiment of the disclosure;

FIG. 2 is a simplified block diagram of an electronic device according to an embodiment of the disclosure;

FIG. 3 illustrates operations executed in at least one first processor, control circuitry, first memory, and second memory to store data regarding a backup version in the second memory according to an embodiment of the disclosure;

FIG. 4 illustrates an operation of an electronic device storing first data in second memory according to an embodiment of the disclosure;

FIG. 5 illustrates operations executed in at least one first processor, control circuitry, and second memory to store first data in the second memory according to an embodiment of the disclosure;

FIG. 6 illustrates operations executed in at least one first processor, control circuitry, first memory, and second memory to restore a state of a second firmware program according to an embodiment of the disclosure;

FIG. 7 illustrates an operation of an electronic device that replaces fourth data with third data according to an embodiment of the disclosure;

FIG. 8 illustrates operations executed in at least one first processor, control circuitry, and second memory to replace fourth data with third data according to an embodiment of the disclosure; and

FIG. 9 is a block diagram of an electronic device in a network environment according to various embodiments.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

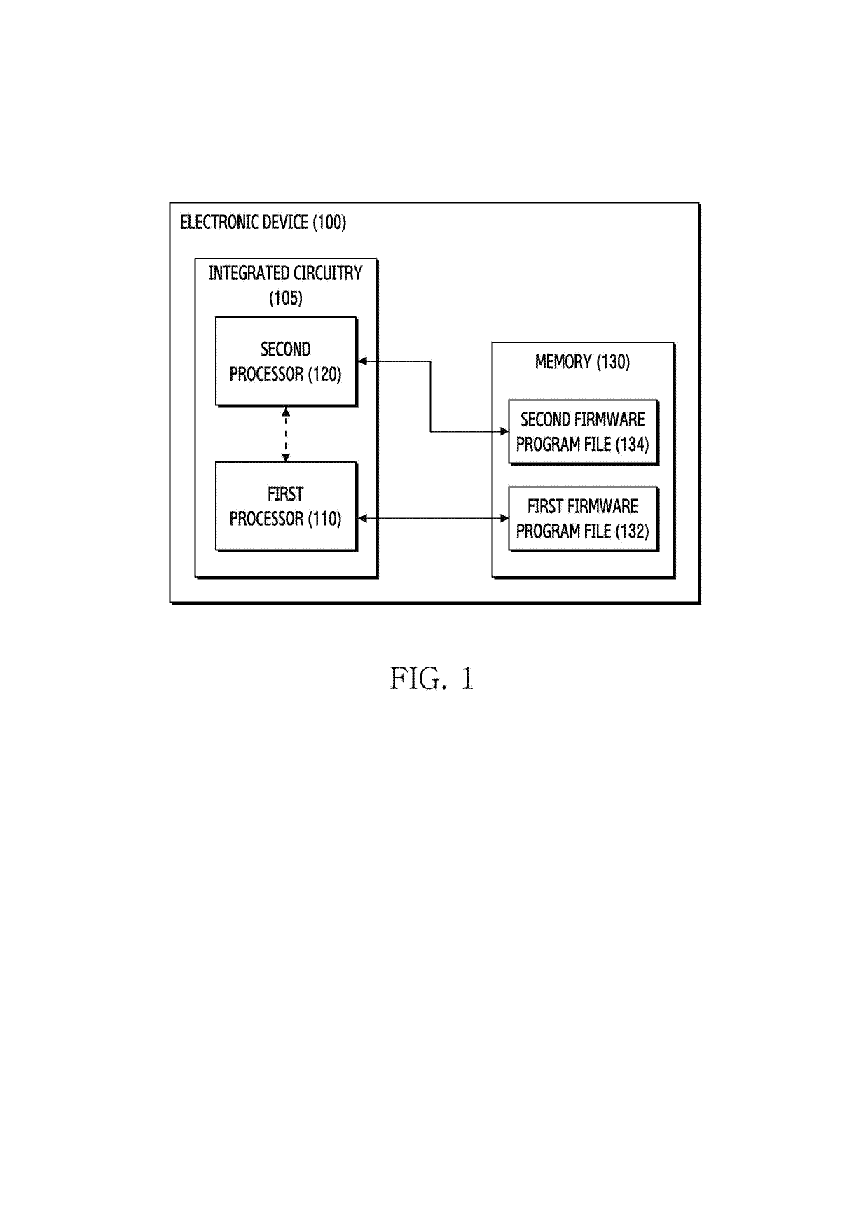

FIG. 1 illustrates an electronic device including memory storing firmware program files according to an embodiment of the disclosure.

Referring to FIG. 1, an electronic device 100 may include integrated circuitry 105 and memory 130. The integrated circuitry 105 may include a first processor 110 and a second processor 120. For example, the memory 130 may store or include a first firmware program file 132 and a second firmware program file 134. The first firmware program file 132 may be described as a file for executing a first firmware program for performing a booting-up of the electronic device 100. The second firmware program file 134 may be described as a file for executing a second firmware program for providing at least a portion of a secure function of the electronic device 100. For example, the first firmware program file 132 may be referred to as the first firmware program. For example, the second firmware program file 134 may be referred to as the second firmware program.

Referring to FIG. 1, a state in which the first firmware program file 132 and the second firmware program file 134 are stored in the memory 130 is illustrated, but an embodiment of the disclosure is not limited thereto. For example, each of the first firmware program file 132 and the second firmware program file 134 may be stored in different memory.

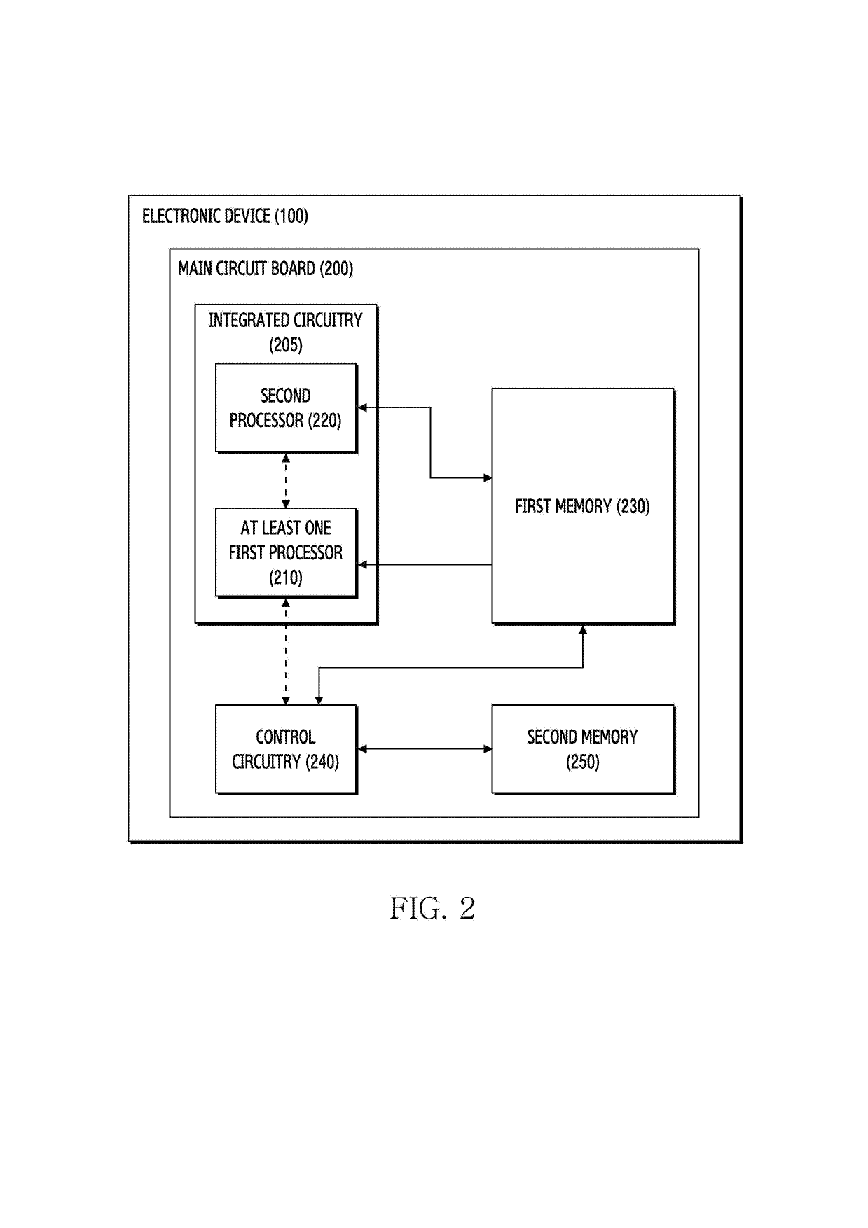

The electronic device 100 may be used to execute at least one of a firmware program and a software application. The first firmware program may be executed through the first processor 110. The second firmware program may be executed through the second processor 120. The first processor 110 may be electrically connected to the second processor 120. For example, when the first processor 110 performs the booting-up the electronic device 100, the first processor 110 may identify a state of the second firmware program using the second processor 120. For example, the first processor 110 may restore the state of the second firmware program to a normal state based on determination that the state of the second firmware program is an abnormal state. For example, the first processor 110 may change the second firmware program file 134 stored in the memory 130 using data regarding a backup version of the second firmware program file 134 that is pre-stored. For example, the data regarding the backup version may be described as data regarding an initial state of the second firmware program file 134. For example, the data regarding the initial state of the second firmware program file 134 may be stored in first memory (e.g., first memory 230 of FIG. 2) or third memory different from the first memory. For example, when executing the first firmware program, the first processor 110 may change or restore the state of the second firmware program file 134 to a state released by a provider based on the state of the second firmware program identified as the abnormal state. For example, restoring the state of the second firmware program file 134 to the state released by the provider may be referred to as a code and/or data resiliency function.

The code and/or data resiliency function may be provided for at least one of a boot partition area and a management engine (ME) data partition. For example, a part of the second firmware program in which the code and/or data resiliency function is provided may be changed by the provider of the second firmware program. For example, not only a first part of the second firmware program that provides the code and/or data resiliency function, but also a second part of the second firmware program that does not provide the code and/or data resiliency function may be required to restore the state of the second firmware program.

When the first processor 110 restores the state of the second firmware program, it may be required for a power state of the first processor to maintain a power-on state. For example, the power-on state may be described as a state in which a voltage is applied to the first processor 110. Since power is consumed by the first processor 110 to change or replace the second firmware program file 134 stored in the memory 130, it may be required to apply the voltage to the first processor 110. For example, when the voltage is not applied to the first processor 110, the state of the second firmware program identified as the abnormal state may not be restored.

When restoring the state of the second firmware program, the first processor 110 may restore the state of the second firmware program to the initial state. For example, the initial state may be described as a state provided by a manufacturer (or the provider) of the second firmware program file 134. For example, at least a portion of the second firmware program file 134 may be updated using a file distributed through the manufacturer as time elapses. For example, when the first processor 110 restores the state of the second firmware program identified as the abnormal state to the initial state, the updated at least a portion of the second firmware program file 134 may be removed. For example, as the state of the second firmware program is restored to the initial state, the electronic device 100 may be required to update the state of the second firmware program in the initial state using data regarding the latest version, in order to execute the second firmware program.

When the first processor 110 is in a power-off state, the electronic device 100 may use control circuitry (e.g., control circuitry 240 of FIG. 2) to restore the state of the second firmware program. For example, the control circuitry included in the electronic device 100 may be configured to replace the at least a portion of the second firmware program file 134 using pre-stored backup data when the power state of the first processor 110 (or the integrated circuitry 105) is identified as the power-off state. For example, since the control circuitry restores the state of the second firmware program from the abnormal state to the normal state using the pre-stored backup data, it may be restored to the state of the second firmware program linked to the latest version of the second firmware program file 134, with respect to the updated at least a portion of the second firmware program file 134, without re-updating.

For example, the electronic device 100 may include hardware components used to perform or execute the operations. The hardware components are described and exemplified with reference to FIG. 2.

FIG. 2 is a simplified block diagram of an electronic device according to an embodiment of the disclosure.

Referring to FIG. 2, an electronic device 100 may include a main circuit board 200. Integrated circuitry 205, first memory 230, control circuitry 240, and second memory 250 may be disposed on the main circuit board 200. The integrated circuitry 205 may include at least one first processor 210 and a second processor 220.

The main circuit board 200 may be a printed circuit board (PCB), a ceramic wiring structure, a glass wiring structure, or the like. However, an embodiment of the disclosure is not limited thereto. The main circuit board 200 may be referred to as a main board. The main circuit board 200 may include conductive pins (or conductive lines) used to connect to at least one of the integrated circuitry 205, the first memory 230, the control circuitry 240, and the second memory 250.

The integrated circuitry 205 may be disposed on the main circuit board 200. The integrated circuitry 205 may include the at least one first processor 210 and the second processor 220. The integrated circuitry 205 may be used to execute a software application or perform an operation. The integrated circuitry 205 may be referred to as a chipset.

The at least one first processor 210 may include a hardware component for processing data using instructions stored in the first memory 230. The hardware component for processing data may include a central processing unit (CPU) (e.g., including processing circuitry). The hardware component for processing data may include a graphic processing unit (GPU) (e.g., including processing circuitry).

The at least one first processor 210 may include one or more cores. For example, the at least one first processor 210 may have a structure of a multi-core processor, such as a dual core, a quad core, or a hexa core.

The second processor 220 may include a hardware component for processing data using instructions stored in the first memory 230. The hardware component for processing data may include a central processing unit (CPU) (e.g., including processing circuitry). The hardware component for processing data may include a graphic processing unit (GPU) (e.g., including processing circuitry).

The second processor 220 may include one or more cores. For example, the second processor 220 may have a structure of a multi-core processor, such as a dual core, a quad core, or a hexa core.

The first memory 230 may include a hardware component for storing data and/or instructions inputted to and/or outputted from the at least one first processor 210. The first memory 230 may include, for example, volatile memory, such as random-access memory (RAM), and/or non-volatile memory, such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (EMMC). However, an embodiment of the disclosure is not limited thereto. For example, the non-volatile memory may include serial peripheral interface read-only memory (SPIROM).

The second memory 250 may include a hardware component for storing data and/or instructions inputted to and/or outputted from the at least one first processor 210. The second memory 250 may include, for example, volatile memory, such as random-access memory (RAM), and/or non-volatile memory, such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disk, and an embedded multimedia card (EMMC). However, the embodiment of the disclosure is not limited thereto. For example, the non-volatile memory may include serial peripheral interface read-only memory (SPIROM).

The control circuitry 240 may be used to store data stored in the first memory 230, in the second memory 250. The control circuitry 240 may be used to replace data stored in the first memory 230 with data stored in the second memory 250. The control circuitry 240 may include a processor. The control circuitry 240 may be referred to as an embedded controller. For example, the control circuitry 240 may be used to perform at least one of managing a power state of the electronic device 100 (or the integrated circuitry 205), monitoring a system, supporting BIOS, providing a secure function (e.g., Trusted Platform Module (TPM)), and updating a firmware program of the electronic device 100. For example, a description regarding the control circuitry 240 may be referred to as a description regarding the second processor 220.

The second processor 220 may be configured to provide at least a portion of the secure function of the integrated circuitry 205 in accordance with a command of the at least one first processor 210. The second processor 220 may be used to execute a second firmware program. The second processor 220 may be referred to as a coprocessor, an engine for providing a secure function, or a module for providing a secure function.

The electronic device 100 may include the main circuit board 200. The integrated circuitry 205 may include the at least one first processor 210, disposed on the main circuit board 200 and configured to perform a booting-up of the electronic device 100, and the second processor 220 configured to provide at least a portion of the secure function of the integrated circuitry 205 in accordance with a command of the at least one first processor 210.

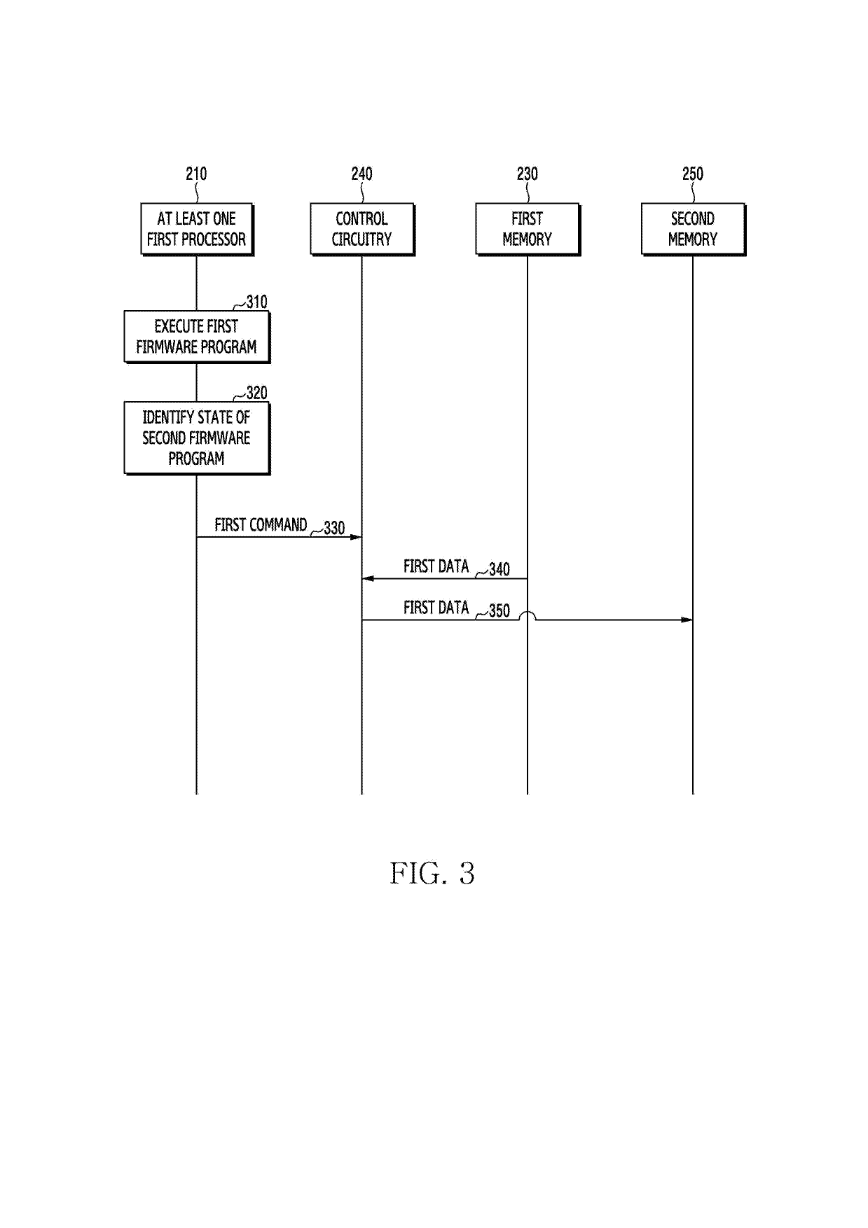

FIG. 3 illustrates operations executed in at least one first processor, control circuitry, first memory, and second memory to store data regarding a backup version in the second memory according to an embodiment of the disclosure.

Referring to FIG. 3, in operation 310, at least one first processor 210 may be configured to execute a first firmware program. For example, the at least one first processor 210 may be configured to execute the first firmware program by using a first firmware program file 132 stored in first memory 230. For example, the first firmware program may include a basic input/output system (BIOS). For example, the first firmware program may include a unified extensible firmware interface (UEFI) BIOS. For example, the at least one first processor 210 may be configured to execute the first firmware program based on a start of a booting-up an electronic device 100.

In operation 320, the at least one first processor 210 may be configured to identify a state of a second firmware program by using the first firmware program. The second firmware program (e.g., converged security and management engine (CSME)) may be described as a firmware program used to provide at least a portion of a secure function. For example, the second firmware program may be executed together with the first firmware program based on the start of the booting-up of the electronic device 100.

The at least one first processor 210 may be configured to identify the state of the second firmware program by using the first firmware program. Integrated circuitry 205 may include a register used to identify the state of the second firmware program. For example, the at least one first processor 210 may be configured to identify the state of the second firmware program by accessing the register used to identify the state of the second firmware program. For example, the at least one first processor 210 may be configured to identify a flag indicating the state of the second firmware program based on accessing the register. For example, the at least one first processor 210 may be configured to identify or determine the state of the second firmware program as an abnormal state based on the flag indicating the state of the second firmware program, which is identified as an error flag. For example, the at least one first processor 210 may be configured to identify or determine the state of the second firmware program as a normal state based on the flag indicating the state of the second firmware program, which is identified as a normal flag (or a flag indicating a predetermined value). For example, the at least one first processor 210 may be configured to identify the state of the second firmware program as the normal state based on the flag identified as a predetermined flag. For example, the predetermined flag may be described as a flag indicating that a function provided through the second firmware program is normally provided. For example, the predetermined flag may be referred to as the normal flag.

The at least one first processor 210 may be configured to identify or determine the state of the second firmware program based on identifying an activation value for the function provided through the second firmware program. For example, the at least one first processor 210 may be configured to determine or identify the state of the second firmware program as the abnormal state based on determination that the activation value for the function provided through the second firmware program is an error value (or an unknown value). For example, the at least one first processor 210 may be configured to determine or identify the state of the second firmware program as the normal state based on the determination that the activation value for the function provided through the second firmware program is the predetermined value (or a normal value).

The at least one first processor 210 may be configured to identify or determine the state of the second firmware program based on checking or identifying an operating mode of the second firmware program. For example, the at least one first processor 210 may be configured to determine or identify the state of the second firmware program as the abnormal state based on determination that the operating mode of the second firmware program is an emergency mode or a recovery mode. For example, the at least one first processor 210 may be configured to determine or identify the state of the second firmware program as the abnormal state based on determination that the second firmware program is in an inactive state when checking the operating mode of the second firmware program.

The at least one first processor 210 may be configured to determine or identify the state of the second firmware program as the abnormal state when the function (e.g., a trusted platform module (TPM) or a camera privacy feature control function) provided through the second firmware program does not operate normally. For example, the at least one first processor 210 may be configured to determine or identify the state of the second firmware program as the abnormal state based on determination that the function provided through the second firmware does not operate normally when an operating system is executed.

The at least one first processor 210 may be configured to identify or determine the state of the second firmware program by using the first firmware program. Operations for identifying the state of the second firmware program have been described, but an embodiment of the disclosure is not limited thereto. For example, a second processor 220 may be configured to identify whether functions provided through the second firmware program may be provided normally in in accordance with a predetermined condition (e.g., when the electronic device 100 performs the booting-up). For example, the second processor 220 may be configured to transmit a result of the identification to the at least one first processor 210. For example, the at least one first processor 210 may be configured to identify the state of the second firmware program based on receiving the result of the identification.

According to an embodiment of the disclosure, control circuitry 240 may be configured to determine the state of the second firmware program as the abnormal state. For example, the control circuitry 240 may be configured to identify a power state of the at least one first processor 210. For example, the control circuitry 240 may be configured to identify the state of the second firmware program by identifying the power state of the at least one first processor 210 when the electronic device 100 is booted up. For example, when the electronic device 100 is booted up based on a signal between the first firmware program and the second firmware program, an abnormal signal sequence may be detected. For example, a signal sequence (or a power sequence) for performing the booting-up may be performed through the first firmware program and the second firmware program. For example, based on determination that the signal sequence performed in the second firmware program is not operating, the control circuitry 240 may be configured to determine the state of the second firmware program as the abnormal state.

In operation 330, the at least one first processor 210 may be configured to transmit a first command to the control circuitry 240 based on determination that the state of the second firmware program is in the normal state. For example, the at least one first processor 210 may be configured to transmit the first command (e.g., BACKUP_START) to the control circuitry 240 based on the state of the second firmware program being identified as the normal state. For example, the first command may be described as a command for generating first data to be used to restore the state of the second firmware program which will be identified as the abnormal state, to the normal state by using at least a portion of a second firmware program file 134 related to the state of the second firmware program being identified as the normal state.

According to an embodiment of the disclosure, the electronic device 100 may include an interface usable for transmitting or receiving a command between the at least one first processor 210 and the control circuitry 240. For example, the interface may include an enhanced serial peripheral interface (eSPI) bus. For example, a data packet regarding the command may be transmitted or received through the interface. For example, the data packet may be transmitted or received by a low pin count (LPC) or an inter-integrated circuit (I2C) technique. However, the embodiment of the disclosure is not limited thereto.

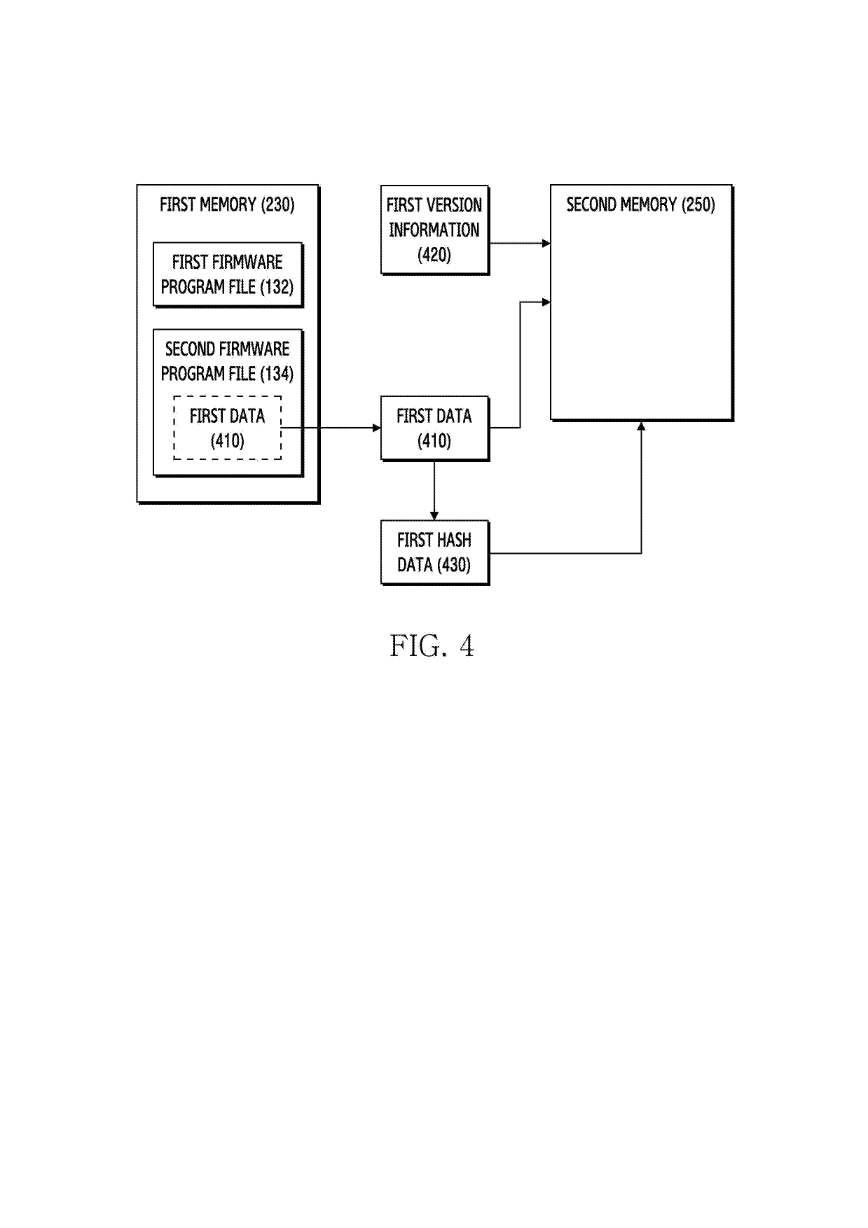

In operation 340, the control circuitry 240 may be configured to obtain, from the first memory 230, the first data used for execution of the second firmware program, stored in the first memory 230. For example, the control circuitry 240 may be configured to obtain, from the first memory 230, the first data (e.g., first data 410 of FIG. 4) linked to the state of the second firmware program being identified as the normal state based on receiving the first command. For example, the first data may be described as at least a portion of the second firmware program file 134. For example, the control circuitry 240 may obtain, from the first memory 230, a backup version (e.g., the first data 410 of FIG. 4) of the second firmware program being identified as the normal state based on the first command received from the at least one first processor 210.

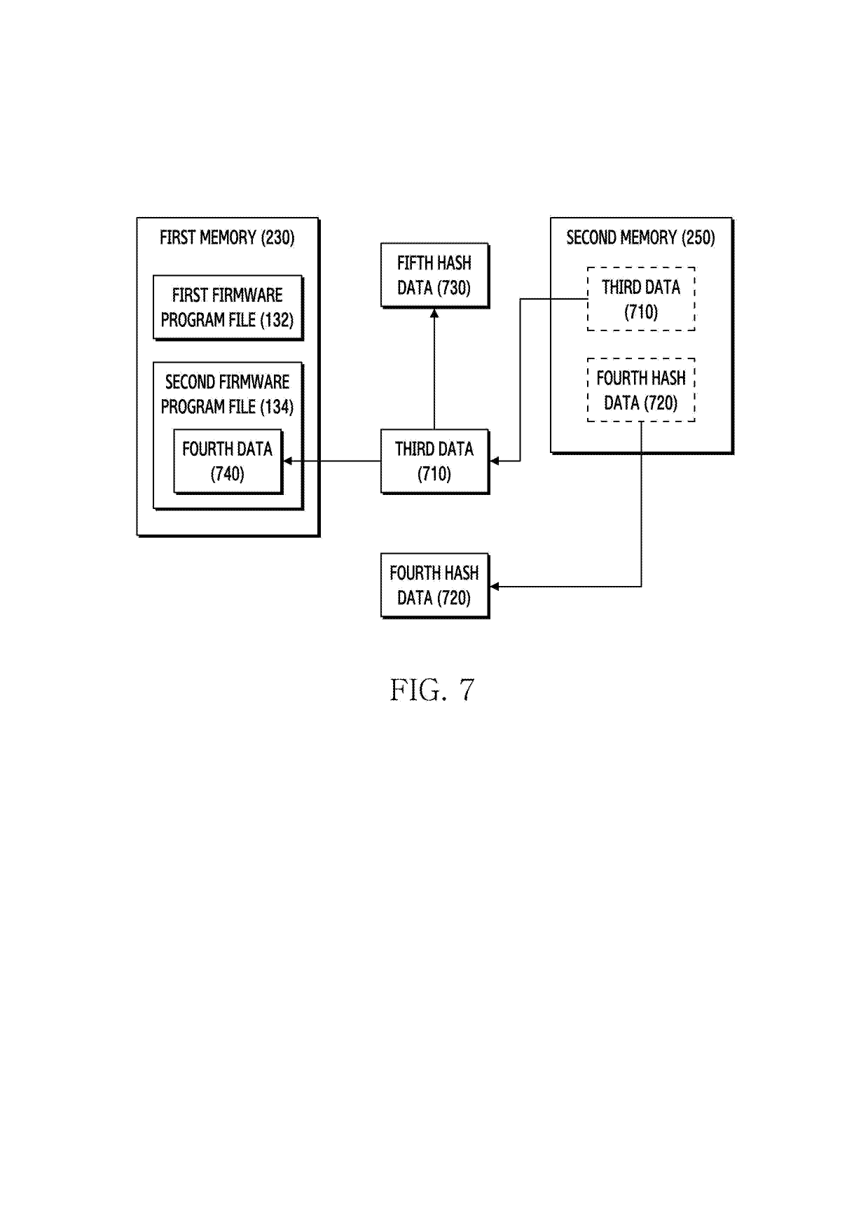

According to an embodiment of the disclosure, the control circuitry 240 may be configured to obtain the first data from the first memory 230 based on identifying a power state of the integrated circuitry 205. For example, the control circuitry 240 may be configured to obtain the first data (e.g., the first data 410 of FIG. 4) from the first memory 230 by accessing the first memory 230, based on determination that the power state of the integrated circuitry 205 is a power-off state. For example, the power-off state may include a G3 state. For example, the G3 state may be described as a G3 (mechanical termination) state in accordance with an advanced configuration and power interface (ACPI) standard. The at least one first processor 210 may be configured to change the power state of the integrated circuitry 205 to the power-off state based on transmitting a command (e.g., a first command, a second command, or a third command). The control circuitry 240 may be configured to identify the power state of the integrated circuitry 205 based on the command received from the at least one first processor 210. The control circuitry 240 may be configured to access the first memory 230 to replace fourth data (e.g., fourth data 740 of FIG. 7) with third data (e.g., third data 710 of FIG. 7) based on the power state of the integrated circuitry 205 being identified as the power-off state.

According to an embodiment of the disclosure, the control circuitry 240 may be configured to identify the power state of the integrated circuitry 205. For example, the at least one first processor 210 may be configured to change the power state of the integrated circuitry 205 to the power-off state based on receiving a user input for changing the power state of the integrated circuitry 205 to the power-off state. The control circuitry 240 may be configured to perform operation 340 based on the power-off state changed in accordance with the user input. However, the embodiment of the disclosure is not limited thereto. For example, the at least one first processor 210 may be configured to change the power state of the integrated circuitry 205 to the power-off state without receiving the user input. For example, since the control circuitry 240 accesses the first memory 230 based on the determination that the power state of the integrated circuitry 205 is the power-off state, the integrated circuitry 205 and the control circuitry 240 may be configured to refrain from simultaneously accessing the first memory 230. A write-protection function may be applied to the first memory 230 with respect to the integrated circuitry 205. For example, an area in the first memory 230 in which the second firmware program file 134 is stored may be described as an area in which the write-protection function is provided.

In operation 350, the control circuitry 240 may be configured to store the first data (e.g., the first data 410 of FIG. 4) in second memory 250. For example, the control circuitry 240 may be configured to store the first data in the second memory 250 to restore the state of the second firmware program which will be identified as the abnormal state, based on obtaining the first data. For example, the control circuitry 240 may be configured to store the backup version (e.g., the first data 410 of FIG. 4) in the second memory 250 to be used to restore the state of the second firmware program which will be identified as the abnormal state. For example, the storage of the first data is described and exemplified with reference to FIG. 4.

FIG. 4 illustrates an operation of an electronic device storing first data in second memory according to an embodiment of the disclosure.

Referring to FIG. 4, control circuitry 240 may be configured to obtain, from first memory 230, at least a portion of a second firmware program file 134 stored in the first memory 230 based on receiving a first command. For example, the control circuitry 240 may be configured to obtain, from the first memory 230, first data 410 in accordance with accessing the first memory 230 based on determination that a power state of integrated circuitry 205 is a power-off state. The control circuitry 240 may be configured to store the first data 410 in second memory 250 based on obtaining the first data 410. For example, the first data 410 may be described as data regarding a backup version of the second firmware program file 134 being identified as a normal state. For example, the first data 410 may be referred to as a first backup version. For example, the first data 410 may be used to restore a state of a second firmware program which will be identified as an abnormal state to the normal state.

According to an embodiment of the disclosure, each of a first firmware program file 132 and the second firmware program file 134 may be stored in the first memory 230. However, an embodiment of the disclosure is not limited thereto. For example, the first firmware program file 132 may be stored in the first memory 230, and the second firmware program file 134 may be stored in third memory (not illustrated).

According to an embodiment of the disclosure, the second memory 250 may include or store instructions that cause an operation of the control circuitry 240. However, the embodiment of the disclosure is not limited thereto. For example, the instructions that cause the operation of the control circuitry 240 may be stored in fourth memory (not illustrated).

According to an embodiment of the disclosure, when storing the first data 410 in the second memory 250, the control circuitry 240 may store first hash data 430 corresponding to the first data 410 together with the first data 410. For example, the control circuitry 240 may obtain the first hash data 430 indicating a first hash value corresponding to the first data 410 using the first data 410 obtained from the first memory 230. For example, when storing the first data 410 in the second memory 250, the control circuitry 240 may store the first hash data 430 and the first data 410 in the second memory 250. For example, the first hash data 430 indicating the first hash value may be used to validate the first data 410. For example, the first hash data 430 may be used to identify whether the first data 410 stored in the second memory 250 is damaged.

According to an embodiment of the disclosure, the integrated circuitry 205 may be configured to refrain from accessing the second memory 250. For example, the integrated circuitry 205 may be prevented from accessing the second memory 250. For example, since the integrated circuitry 205 is prevented from accessing the second memory 250, data (e.g., third data 710 of FIG. 7) regarding a backup version in the second memory 250 may be protected.

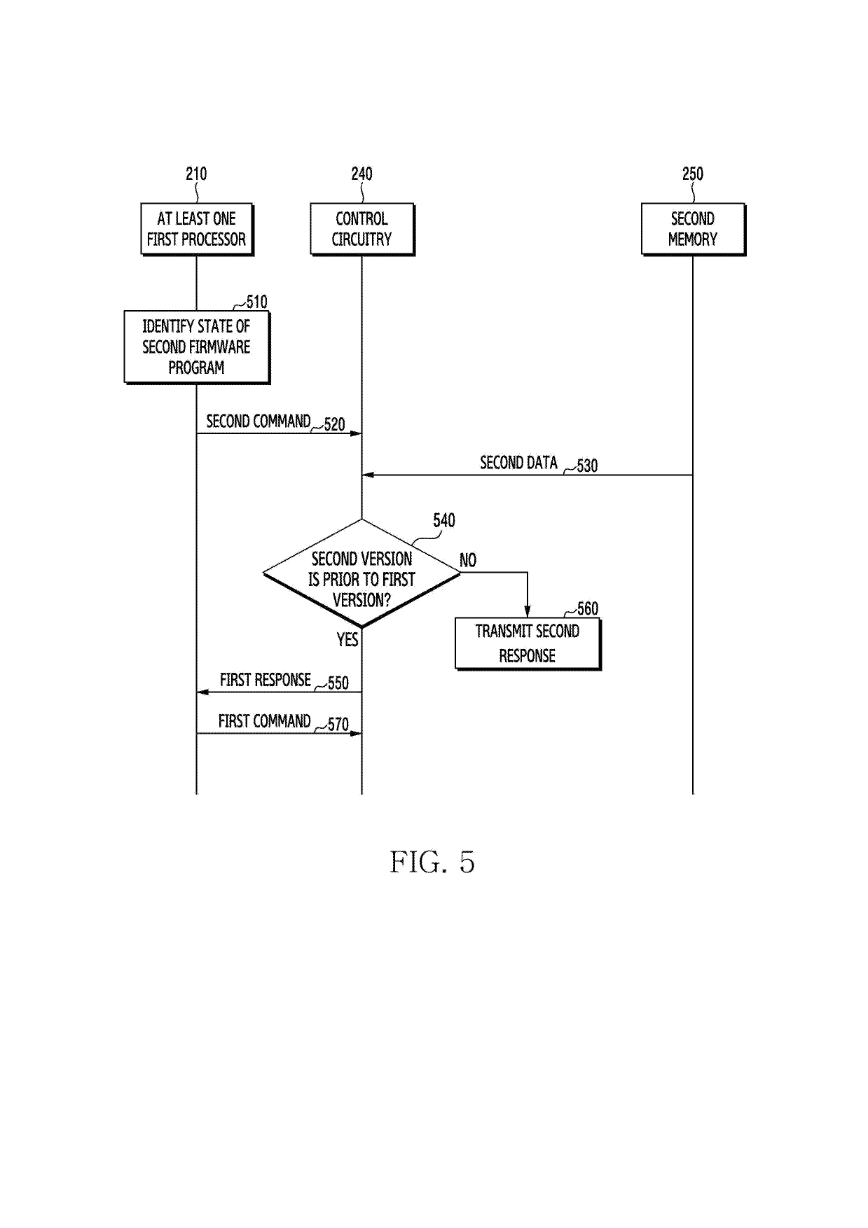

According to an embodiment of the disclosure, at least one first processor 210 may transmit first version information 420 together with the first command to the control circuitry 240. For example, the first version information 420 may be described as information indicating a version of the second firmware program file 134 stored in the first memory 230. For example, the version of the second firmware program may be changed based on an update. For example, the control circuitry 240 may store the received first version information 420 together with the first data 410 in the second memory 250. For example, the first version information 420 may be used to determine whether to store the first data 410 included in the second firmware program file 134 stored in the first memory 230, in the second memory 250 for restoration. For example, an operation of determining whether to store the first data 410 in the second memory 250 based on version information is described and exemplified with reference to FIG. 5.

FIG. 5 illustrates operations executed in at least one first processor, control circuitry, and second memory to store first data in the second memory according to an embodiment of the disclosure.

Referring to FIG. 5, in operation 510, at least one first processor 210 may be configured to identify a state of a second firmware program. For example, the at least one first processor 210 may be configured to identify the state of the second firmware program using a first firmware program executed in the at least one first processor 210. For example, the operation 510 may correspond to the operation 320 of FIG. 3.

In operation 520, the at least one first processor 210 may be configured to transmit a second command (e.g., GET_BACKUP_STATUS) to control circuitry 240 based on the state of the second firmware program being identified as a normal state. For example, the second command may be described as a command for identifying a state of data stored in second memory 250. For example, the at least one first processor 210 may be configured to transmit the second command to the control circuitry 240 before transmitting a first command. For example, the at least one first processor 210 may determine whether to transmit the first command based on a response to the second command.

In operation 530, the control circuitry 240 may be configured to obtain second data from the second memory 250 based on receiving the second command. For example, the second data may be described as at least a portion of the second firmware program file 134 stored in the second memory 250.

According to an embodiment of the disclosure, the control circuitry 240 may be configured to transmit, based on a determination that there is no data indicating the at least a portion of the second firmware program file 134 in the second memory 250, a response indicating the determination to the at least one first processor 210. For example, the at least one first processor 210 may be configured to transmit the first command to the control circuitry 240 based on receiving the response. For example, the control circuitry 240 may be configured to determine whether the second data for restoring a state of the second firmware is stored in the second memory 250, in accordance with accessing the second memory 250, based on receiving the second command. For example, based on determination that the second data is not stored in the second memory 250, the control circuitry 240 may be configured to transmit the response indicating the determination to the at least one first processor 210. For example, the at least one first processor 210 may be configured to transmit the first command to the control circuitry 240 based on receiving the response.

In operation 540, the control circuitry 240 may be configured to determine whether a second version of the second data is prior to a first version. The control circuitry 240 may be configured to execute operation 550 based on determination that the second version of the second data is prior to the first version, and execute operation 560 based on determination that the second version is not prior to the first version. For example, the control circuitry 240 may be configured to receive, from the at least one first processor 210, first version information 420 indicating the first version of a first firmware program file 132 stored in first memory 230, together with the second command. For example, the control circuitry 240 may be configured to obtain the second data and second version information from the second memory 250, based on receiving the second command and the first version information 420. For example, the second version information may be described as information indicating a version of the second data. For example, the second version information may be described as version information regarding the second data, which is stored together with the second data when the second data was stored in the second memory 250.

In operation 550, based on determination that the second version of the second data is prior to a first version of the second firmware program file 134 stored in the first memory 230, the control circuitry 240 may be configured to transmit a first response indicating the determination to the at least one first processor 210.

According to an embodiment of the disclosure, the control circuitry 240 may be configured to transmit the first response indicating the determination and a version of the second data to the at least one first processor 210. For example, based on the determination that the second version of the second data is prior to the first version of the second firmware program file 134 stored in the first memory 230, the control circuitry 240 may be configured to transmit the first response indicating that the determination and the second data stored in the second memory 250 is the second version to the at least one first processor 210.

In operation 560, based on determination that the second version of the second data is not prior to the first version of the second firmware program file 134 stored in the first memory 230, the control circuitry 240 may be configured to transmit a second response indicating the determination to the at least one first processor 210. For example, the at least one first processor 210 may be configured to refrain from, bypass, or block transmitting the first command to the control circuitry 240 based on receiving the second response. For example, when the second version of the second data is identical to the first version of the second firmware program file 134 stored in the first memory 230, or is prior to the first version, the at least one first processor 210 may be configured to refrain from storing new data regarding a backup version in the second memory 250.

According to an embodiment of the disclosure, the control circuitry 240 may be configured to validate validity of the second data using a hash value based on the determination that the second version of the second data is not prior to the first version. For example, when the second version is not prior to the first version, the second version may be identical to the first version, or the second version may be prior to the first version. For example, the control circuitry 240 may be configured to obtain second hash data indicating a second hash value together with the second data from the second memory 250. For example, the control circuitry 240 may be configured to obtain third hash data indicating a third hash value corresponding to the second data using the second data based on obtaining the second data from the second memory 250. For example, the control circuitry 240 may be configured to determine that the second data is valid based on determination that the second hash value is identical to the third hash value. For example, the control circuitry 240 may be configured to transmit the second response to the at least one first processor 210 based on the determination that the second data is valid. For example, the control circuitry 240 may be configured to determine that the second data is invalid based on determination that the second hash value is different from the third hash value. For example, the control circuitry 240 may be configured to transmit the first response to the at least one first processor 210 based on the determination that the second data is not valid.

According to an embodiment of the disclosure, the control circuitry 240 may be configured to identify or determine whether the second hash value is identical to the third hash value based on determination that the second version of the second data is prior to the first version. For example, based on determination that the second version is prior to the first version and that the second hash value is identical to the third hash value, the control circuitry 240 may be configured to transmit a response indicating the determination to the at least one first processor 210. For example, the at least one first processor 210 may be configured to transmit the first command to the control circuitry 240 based on receiving the response.

In operation 570, the at least one first processor 210 may be configured to transmit the first command to the control circuitry 240 based on receiving the first response. For example, the at least one first processor 210 may be configured to determine whether to store the first data regarding the second firmware program file 134 stored in the first memory 230, in the second memory 250, based on receiving the first response. An operation of executing the operation 570 based on the operations 520 to 550 has been described, but an embodiment of the disclosure is not limited thereto. For example, at least one of the operations 520 to 560 may be omitted.

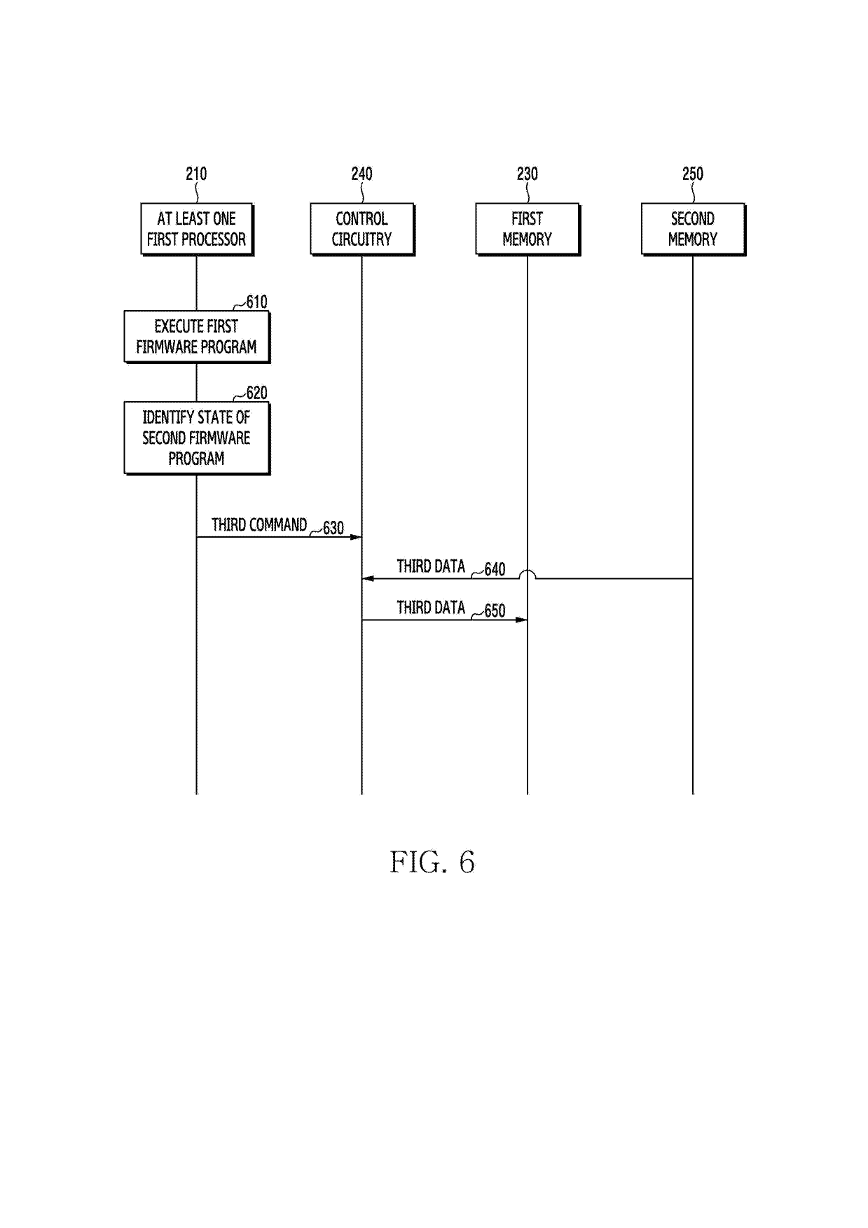

The at least one first processor 210 may identify a state of the second firmware program based on a start of a booting-up of an electronic device 100 by using the first firmware program. The at least one first processor 210 may be configured to restore the state of the second firmware program to the normal state by using third data (e.g., third data 710 of FIG. 7) regarding a backup version of the state of the second firmware program, which was identified as the normal state, based on the state of the second firmware program being identified as an abnormal state. For example, the restoration is described and exemplified with reference to FIG. 6.

FIG. 6 illustrates operations executed in at least one first processor, control circuitry, first memory, and second memory to restore a state of a second firmware program according to an embodiment of the disclosure.

Referring to FIG. 6, in operation 610, at least one first processor 210 may be configured to execute a first firmware program based on a start of a booting-up of an electronic device 100. For example, the operation 610 may correspond to the operation 310 of FIG. 3.

In operation 620, the at least one first processor 210 may be configured to identify a state of a second firmware program using a first firmware program. For example, the operation 620 may correspond to the operation 320 of FIG. 3.

In operation 630, the at least one first processor 210 may be configured to transmit a third command (e.g., RECOVERY_START) to control circuitry 240 based on the state of the second firmware program being identified as an abnormal state. For example, the third command may be described as a command that causes at least a portion of a second firmware program file 134 stored in first memory 230 to be replaced using third data stored in second memory 250.

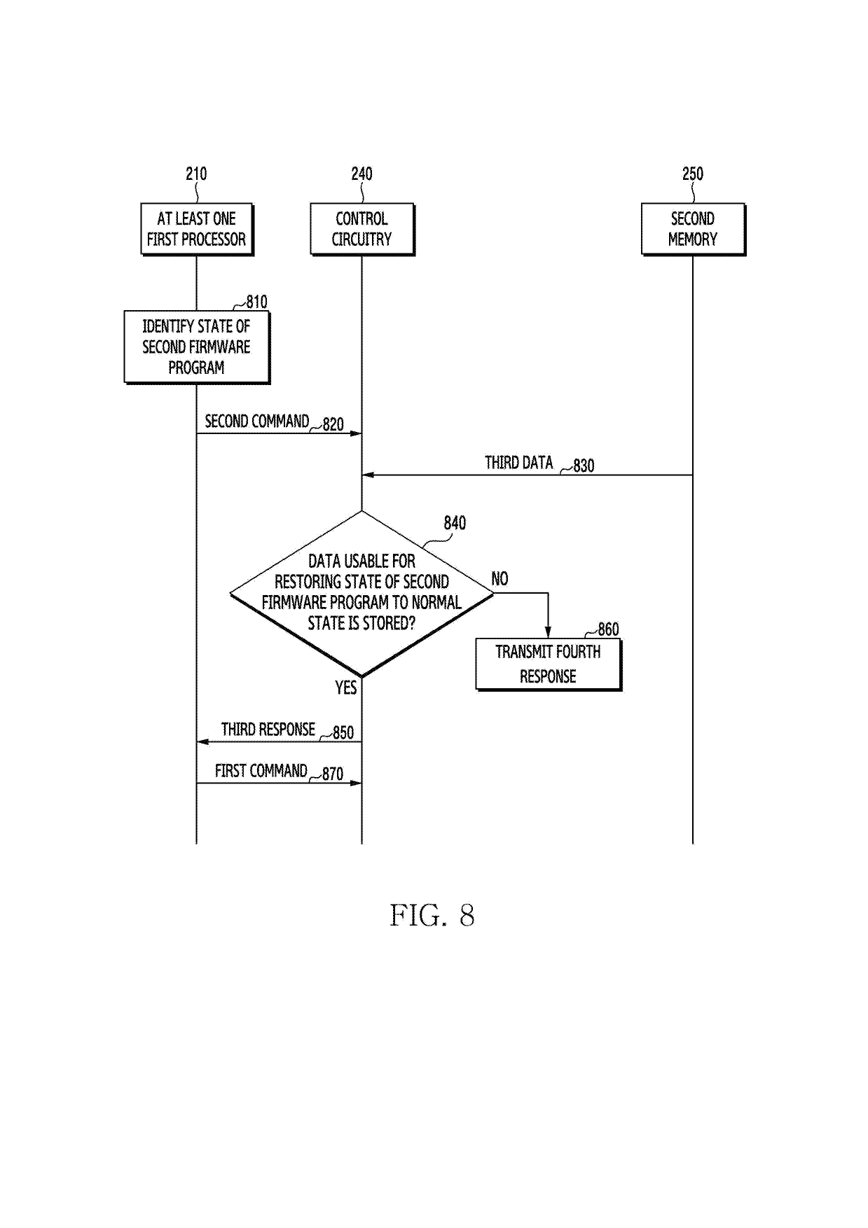

In operation 640, the control circuitry 240 may be configured to obtain, from the second memory 250, the third data (e.g., third data 710 of FIG. 7) for a backup version of the second firmware program which was identified (or was determined) as a normal state, based on receiving the third command. For example, the control circuitry 240 may be configured to use a hash value to determine or identify whether the third data is usable for restoring the state of the second firmware program. For example, the control circuitry 240 may be configured to obtain, from the second memory 250, the backup version (e.g., the third data 710 of FIG. 7) of the second firmware program which was backed up when the state of the second firmware program is identified as the normal state, based on the third command received from the at least one first processor 210. For example, an operation of determining whether the third data is usable for restoring the state of the second firmware program will be described later with reference to FIG. 8.

According to an embodiment of the disclosure, the at least one first processor 210 may be configured to change a power state of integrated circuitry 205 to a power-off state based on the state of the second firmware program being identified as the abnormal state. For example, the control circuitry 240 may be configured to access the first memory 230 based on a state of the integrated circuitry 205 being identified as the power-off state. However, an embodiment of the disclosure is not limited thereto. For example, the at least one first processor 210 may be configured to change the power state of the integrated circuitry 205 to the power-off state based on receiving a user input for changing the power state of the integrated circuitry 205 to the power-off state. For example, the control circuitry 240 may be configured to access the first memory 230 based on the power-off state changed in accordance with the user input.

In operation 650, the control circuitry 240 may be configured to replace or overwrite fourth data stored in the first memory 230 with the third data (e.g., the third data 710 of FIG. 7). For example, the fourth data may be described as at least a portion of the second firmware program file 134 stored in the first memory 230. For example, the fourth data may be described as data regarding the second firmware program being identified as the abnormal state. The control circuitry 240 may be configured to replace the fourth data stored in the first memory 230 with the third data (e.g., the third data 710 of FIG. 7) to restore the state of the second firmware program being identified as the abnormal state based on accessing the first memory 230. For example, the control circuitry 240 may be configured to replace the at least a portion (e.g., the fourth data 740 of FIG. 7) of the second firmware program stored in the first memory 230 with the backup version (e.g., the third data 710 of FIG. 7).

Since the control circuitry 240 may restore the state of the second firmware program from the abnormal state to the normal state, a provider (or a manufacturer) of the second firmware program may expect to be restored from the abnormal state to the normal state without further action.

According to an embodiment of the disclosure, the at least one first processor 210 may be configured to execute the first firmware program based on the start of the booting-up of the electronic device 100 after the at least a portion (e.g., the fourth data 740 of FIG. 7) of the second firmware program is replaced with the backup version (e.g., the third data 710 of FIG. 7). For example, a second processor 220 may be configured to execute the second firmware program based on the start of the booting-up of the electronic device 100. For example, after the at least a portion (e.g., the fourth data 740 of FIG. 7) of the second firmware program is replaced with the backup version (e.g., the third data 710 of FIG. 7), the state of the second firmware program executed through the second processor 220 may be identified as the normal state. The at least one first processor 210 may be configured to identify the state of the second firmware program as the normal state in accordance with restoration based on the backup version by using the first firmware program. For example, the at least one first processor 210 may be configured to perform the booting-up of the electronic device 100 based on transmitting the third command. For example, based on replacing the at least a portion (e.g., the fourth data 740 of FIG. 7) of the second firmware program with the backup version (e.g., the third data 710 of FIG. 7), the control circuitry 240 may be configured to transmit a signal indicating the replacement to the at least one first processor 210.

According to an embodiment of the disclosure, the at least one first processor 210 may be configured to transmit offset information together with the third command to the control circuitry 240. For example, the control circuitry 240 may be configured to receive the offset information together with the third command. For example, the offset information may be described as information indicating data that is required to be replaced among the second firmware program file 134. For example, the offset information may be described as information indicating a location where the data that is required to be replaced is stored among the first memory 230 in which the second firmware program file 134 is stored. For example, the control circuitry 240 may be configured to identify or determine a part of the second firmware program file 134 that is required to be replaced using the offset information. For example, the control circuitry 240 may be configured to replace a portion of the fourth data corresponding to the part of the second firmware program and stored in the first memory 230 with a portion of the third data (e.g., the third data 710 of FIG. 7) corresponding to the part of the second firmware program and stored in the second memory 250.

The at least one first processor 210 may be configured to transmit the command and the offset information to the control circuitry 240 based on the state of the second firmware program being identified as the abnormal state. The control circuitry 240 may be configured to identify a part of the second firmware program to be restored using the offset information. The control circuitry 240 may be configured to replace a second portion of the fourth data 740 corresponding to the part of the second firmware program with a first portion of the third data 710 corresponding to the part of the second firmware program, based on accessing the first memory 230.

According to an embodiment of the disclosure, the control circuitry 240 may be configured to refer to address and size information of the second firmware program file 134 stored in the first memory 230 to obtain offset information for the restoration. For example, the control circuitry 240 may be configured to determine an area in the first memory 230, defined through the offset information, as a target to be backed up and/or restored.

The control circuitry 240 may be configured to replace at least a portion of the second firmware program file 134 stored in the first memory 230 with the third data 710 stored in the second memory 250. For example, the replacement is described and exemplified with reference to FIG. 7.

FIG. 7 illustrates an operation of an electronic device that replaces fourth data with third data according to an embodiment of the disclosure.

Referring to FIG. 7, control circuitry 240 may be configured to obtain third data 710 from second memory 250 based on receiving a third command. The control circuitry 240 may be configured to replace fourth data 740 stored in first memory 230 with the third data 710. The third data 710 may be described as data regarding a backup version of a second firmware program that was backed up when a state of the second firmware program is identified as a normal state. For example, the third data 710 may be referred to as a second backup version of the second firmware program. The fourth data 740 may be referred to as at least a portion of the second firmware program file 134 or at least a portion of the second firmware program.

According to an embodiment of the disclosure, the control circuitry 240 may be configured to identify a power state of integrated circuitry 205. The control circuitry 240 may be configured to access the first memory 230 based on determination that the power state of the integrated circuitry 205 is a power-off state. For example, the control circuitry 240 may be configured to access the first memory 230 to restore the state of the second firmware program from an abnormal state to the normal state, based on the power state of the integrated circuitry 205 being identified as the power-off state.

According to an embodiment of the disclosure, the control circuitry 240 may be configured to validate validity of the third data 710 stored in the second memory 250 by using a hash value. For example, the fourth hash data 720 may have been obtained from the third data 710 when the third data 710 is stored in the second memory 250. For example, before the third data 710 is stored in the second memory 250, the control circuitry 240 may be configured to obtain fourth hash data 720 corresponding to the third data 710. For example, the control circuitry 240 may be configured to validate the validity of the third data 710 by using the fourth hash data 720 which was stored together with the third data 710. For example, when obtaining the third data 710 from the second memory 250, the control circuitry 240 may be configured to obtain the fourth hash data 720 indicating a fourth hash value from the second memory 250 together with the third data 710. For example, the control circuitry 240 may be configured to obtain fifth hash data 730 corresponding to the third data 710 and indicating a fifth hash value by using the third data 710 based on obtaining the third data 710. For example, the control circuitry 240 may be configured to identify or determine whether the fourth hash value is identical to the fifth hash value to validate the validity of the third data 710. For example, the control circuitry 240 may be configured to determine that the third data 710 stored in the second memory 250 is valid based on determination that the fourth hash value is identical to the fifth hash value. For example, the control circuitry 240 may be configured to determine that the third data 710 stored in the second memory 250 is usable for restoring a state of the second firmware based on the determination that the fourth hash value is identical to the fifth hash value. For example, the control circuitry 240 may be configured to access the first memory 230 to replace the fourth data 740 with the third data 710 based on the determination that the fourth hash value is identical to the fifth hash value.

The control circuitry 240 may be configured to determine or identify whether the data usable for restoring the state of the second firmware program is stored in the second memory 250. For example, the determination is described and exemplified with reference to FIG. 8.

FIG. 8 illustrates operations executed in at least one first processor, control circuitry, and second memory to replace fourth data with third data according to an embodiment of the disclosure.

Referring to FIG. 8, in operation 810, at least one first processor 210 may be configured to identify a state of a second firmware program based on a start of a booting-up of an electronic device 100. For example, the operation 810 may correspond to the operation 320 of FIG. 3.

In operation 820, the at least one first processor 210 may be configured to transmit a second command to control circuitry 240 based on the state of the second firmware program being identified as an abnormal state.

In operation 830, the control circuitry 240 may be configured to obtain third data 710 from second memory 250 based on receiving the second command. For example, the third data 710 may be described as data regarding a backup version of the second firmware program which was identified (or was determined) as a normal state, stored in the second memory 250.

In operation 840, the control circuitry 240 may be configured to determine or identify whether data usable for restoring the state of the second firmware program to the normal state is stored in the second memory 250. For example, the control circuitry 240 may execute operation 850 based on determination that the data usable for restoring the state of the second firmware program to the normal state is stored in the second memory 250, and may be configured to execute operation 860 based on determination that the data usable for restoring the state of the second firmware program to the normal state is not stored in the second memory 250. For example, the control circuitry 240 may be configured to determine whether the data usable for restoring the state of the second firmware program to the normal state is stored in the second memory 250, by using a hash value. For example, the control circuitry 240 may be configured to use the hash value to validate validity of the third data 710 stored in the second memory 250.

The control circuitry 240 may be configured to obtain, from the second memory 250, fourth hash data 720 indicating a fourth hash value together with the third data 710 based on receiving the second command. For example, the control circuitry 240 may be configured to obtain fifth hash data 730, corresponding to the third data 710 and indicating a fifth hash value, based on obtaining the third data 710. The control circuitry 240 may be configured to determine that the data usable for restoring the state of the second firmware program to the normal state is stored in the second memory 250 based on determination that the fourth hash value is identical to the fifth hash value. For example, the control circuitry 240 may be configured to determine that the data usable for restoring the state of the second firmware program to the normal state is not stored in the second memory 250, based on determination that the fourth hash value is different from the fifth hash value.

In the operation 850, based on the determination that the data usable for restoring the state of the second firmware program to the normal state is stored in the second memory 250, the control circuitry 240 may be configured to transmit a third response indicating the determination to the at least one first processor 210.

According to an embodiment of the disclosure, the control circuitry 240 may be configured to transmit, to at least one first processor 210, the third response indicating the determination and a version of the third data 710, based on the determination that the data usable for restoring the state of the second firmware program to the normal state is stored in the second memory 250.

In operation 870, the at least one first processor 210 may be configured to transmit a first command to the control circuitry 240 based on receiving the third response. For example, the control circuitry 240 may be configured to replace fourth data 740 stored in the first memory 230 to restore the state of the second firmware program to the normal state, with the third data 710 stored in the second memory 250, based on receiving the first command.

In the operation 860, based on the determination that the data usable for restoring the state of the second firmware program to the normal state is not stored in the second memory 250, the control circuitry 240 may be configured to transmit a fourth response indicating the determination, to the at least one first processor 210. The at least one first processor 210 may be configured to refrain from, bypass, or block transmitting the first command to the control circuitry 240 based on receiving the fourth response.

Operations of executing the operation 870 based on the operations 820 to 850 have been described, but an embodiment of the disclosure is not limited thereto. For example, at least one of the operations 820 to 860 may be omitted.

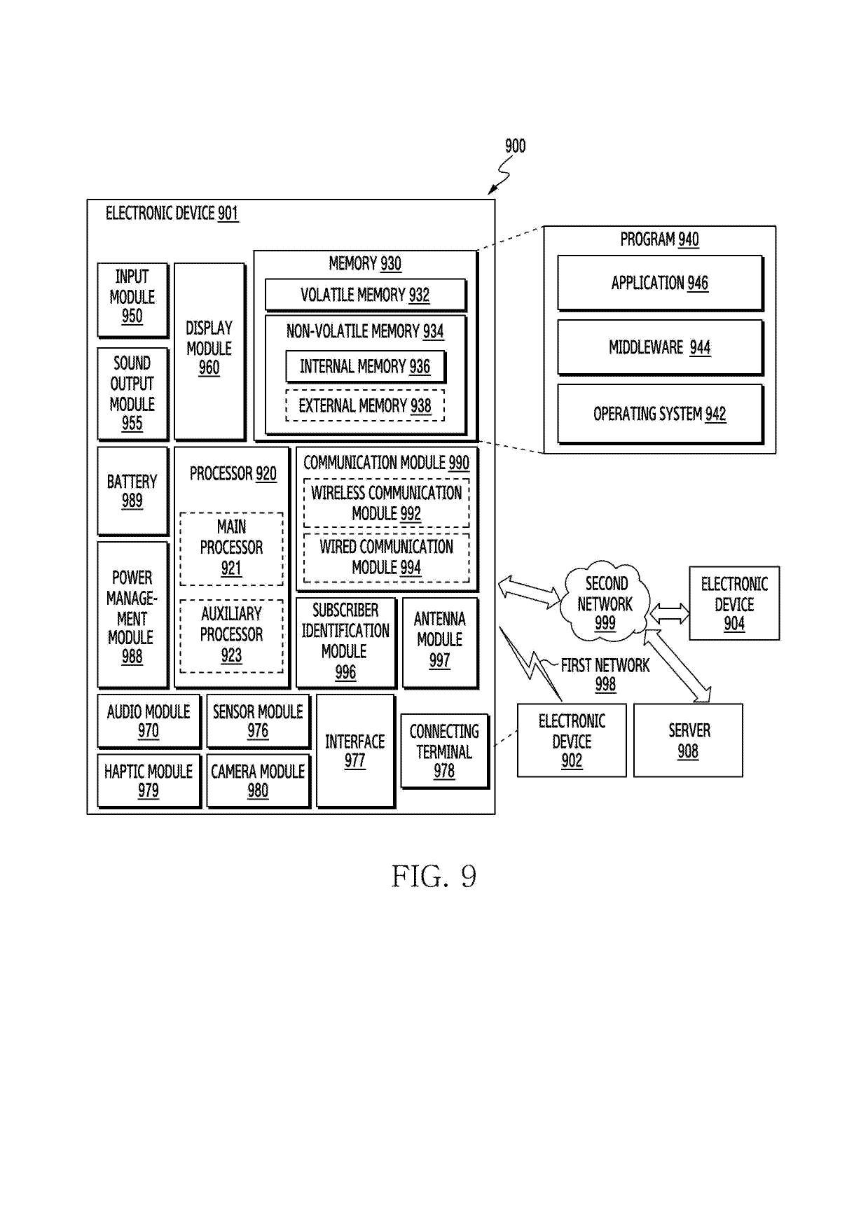

FIG. 9 is a block diagram illustrating an electronic device in a network environment according to various embodiments.

Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module(SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20Gbps or more) for implementing eMBB, loss coverage (e.g., 964dB or less) for implementing mMTC, or U-plane latency (e.g., 0.5ms or less for each of downlink (DL) and uplink (UL), or a round trip of 9ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

The technical problems to be achieved in this document are not limited to those described above, and other technical problems not mentioned herein will be clearly understood by those having ordinary knowledge in the art to which the disclosure belongs, from the following description.

As described above, an electronic device (e.g., the electronic device 100) may comprise a main circuit board (e.g., the main circuit board 200). The electronic device may comprise integrated circuitry (e.g., the integrated circuitry 205), mounted on the main circuit board. The integrated circuitry may comprise at least one first processor, and a second processor. The electronic device may comprise first non-volatile memory, mounted on the main circuit board, comprising one or more storage media. The one or more storage media included in the first non-volatile memory may store a first firmware program configured to be executed by the at least one first processor individually or collectively for performing a booting-up of the electronic device. The one or more storage media included in the first non-volatile memory may store a second firmware program, configured to be executed by the second processor, for providing at least a portion of a secure function in accordance with a command of the at least one first processor. The electronic device may comprise second non-volatile memory, mounted on the main circuit board, comprising one or more storage media. The electronic device may comprise control circuitry, mounted on the main circuit board, electrically connected to the at least one first processor, the first non-volatile memory, and the second non-volatile memory. The at least one first processor may be configured to, based on a start of the booting-up of the electronic device, execute the first firmware program. The at least one first processor may be configured to identify, using the first firmware program, a state of the second firmware program that is executed by the second processor based on the start of the booting-up of the electronic device. The at least one first processor may be configured to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

According to an embodiment of the disclosure, the at least one first processor may be configured to, based on transmitting the command, change a power state of the integrated circuitry to a power-off state. The control circuitry may be configured to, based on the command received from the at least one first processor, identify the power state of the integrated circuitry. The control circuitry may be configured to, based on the power state of the integrated circuitry being identified as the power-off state, access the first non-volatile memory for replacing the at least a portion of the second firmware program with the backup version.

According to an embodiment of the disclosure, the power-off state may include a G3 state.

According to an embodiment of the disclosure, the first firmware program may include a basic input-output system (BIOS).

According to an embodiment of the disclosure, the at least one first processor may be configured to, after the at least a portion of the second firmware program is replaced with the backup version, based on a start of the booting-up of the electronic device, execute the first firmware program. The at least one first processor may be configured to identify, using the first firmware program, as the normal state, a state of the second firmware program in accordance with a restoration based on the backup version.

According to an embodiment of the disclosure, the integrated circuitry may further comprise a register used to identify the state of the second firmware program. The at least one first processor may be configured to, when identifying the state of the second firmware program using the first firmware program, based on accessing the register, identify a flag indicating the state of the second firmware program. The at least one first processor may be configured to, based on the flag being identified as an error flag, identify the state of the second firmware program as the abnormal state.

According to an embodiment of the disclosure, the control circuitry may be configured to, based on the command received from the at least one first processor, obtain, from the second non-volatile memory, the backup version and first hash data indicating a first hash value. The control circuitry may be configured to, using the backup version, obtain second hash data indicating a second hash value corresponding to the backup version. The control circuitry may be configured to, based on determination that the first hash value is identical to the second hash value, access the first non-volatile memory for replacing the at least a portion of the second firmware program with the backup version.

According to an embodiment of the disclosure, the at least one first processor may be configured to, based on the state of the second firmware program being identified as the abnormal state, transmit, to the control circuit, the command and offset information. The control circuitry may be configured to, using the offset information, identify a part of the second firmware program to be restored. The control circuitry may be configured to, based on accessing the first non-volatile memory, replace, with a first portion of the backup version corresponding to the part of the second firmware program, a second portion of the second firmware program corresponding to the part of the second firmware program.

According to an embodiment of the disclosure, the command may be a first command. The at least one first processor may be configured to, based on the state of the second firmware program being identified as the abnormal state, transmit, to the control circuitry, a second command. The control circuitry may be configured to, based on receiving the second command, determine whether the backup version usable for restoring the state of the second firmware program is stored in the second non-volatile memory using a hash value. The control circuitry may be configured to, based on determination that the backup version usable for restoring the state of the second firmware program is stored in the second non-volatile memory, transmit, to the at least one first processor, a response indicating the determination. The at least one first processor may be configured to, based on receiving the response, transmit, to the control circuitry, the first command.

According to an embodiment of the disclosure, the control circuitry may be configured to, based on receiving the second command, obtain, from the second non-volatile memory, the backup version and third hash data indicating a third hash value for determining whether the backup version usable for restoring the state of the second firmware program is stored in the second non-volatile memory. The control circuitry may be configured to, using the backup version, obtain fourth hash data indicating a fourth hash value corresponding to the backup version. The control circuitry may be configured to, based on determination that the third hash value is identical to the fourth hash value, determine that the backup version is usable for restoring the state of the second firmware program.

According to an embodiment of the disclosure, the control circuitry may include a third processor for executing a third firmware program. The third firmware program may be used to monitor a power state of the integrated circuitry and to update a firmware program of the electronic device.

As described above, an electronic device (e.g., the electronic device 100) may comprise a main circuit board (e.g., the main circuit board 200). The electronic device may comprise integrated circuitry (e.g., the integrated circuitry 205), mounted on the main circuit board. The integrated circuitry may comprise at least one first processor, and a second processor. The electronic device may comprise first non-volatile memory, mounted on the main circuit board, comprising one or more storage media. The one or more storage media included in the first nonvolatile memory may store a first firmware program configured to be executed by the at least one first processor individually or collectively for performing a booting-up of the electronic device. The one or more storage media included in the first nonvolatile memory may store a second firmware program, configured to be executed by the second processor, for providing at least a portion of a secure function in accordance with a command of the at least one first processor. The electronic device may comprise second non-volatile memory, mounted on the main circuit board, comprising one or more storage media. The electronic device may comprise control circuitry, mounted on the main circuit board, electrically connected to the at least one first processor, the first non-volatile memory, and the second non-volatile memory. The at least one first processor may be configured to, based on a start of a booting-up of the electronic device, execute the first firmware program. The at least one first processor may be configured to identify, using the first firmware program, a state of the second firmware program that is executed by the second processor based on the start of the booting-up of the electronic device. The at least one first processor may be configured to, based on the state of the second firmware program being identified as a normal state, transmit, to the control circuitry, a command. The control circuitry may be configured to, based on the command received from the at least one first processor, obtain, from the first non-volatile memory, a backup version of the second firmware program being identified as the normal state. The control circuitry may be configured to store, in the second non-volatile memory, the backup version to be used to restore a state of the second firmware program which will be identified as an abnormal state to the normal state.

According to an embodiment of the disclosure, the at least one first processor may be configured to, based on transmitting the command, change a power state of the integrated circuitry to a power-off state. The control circuitry may be configured to, based on the command received from the at least one first processor, identify the power state of the integrated circuitry. The control circuitry may be configured to, based on the power state of the integrated circuitry being identified as the power-off state, access the first non-volatile memory for obtaining the backup version.

According to an embodiment of the disclosure, the power-off state may include a G3 state.

According to an embodiment of the disclosure, the first firmware program may include a basic input-output system (BIOS).

According to an embodiment of the disclosure, the integrated circuitry may further comprise a register used to identify a state of the second firmware program. The at least one first processor may be configured to, when identifying the state of the second firmware program using the first firmware program, based on accessing the register, identify a flag indicating the state of the second firmware program. The at least one first processor may be configured to, based on the flag being identified as a predetermined flag, identify the state of the second firmware program as the normal state.

According to an embodiment of the disclosure, the control circuitry may be configured to, based on obtaining the backup version, obtain hash data corresponding to the backup version. The control circuitry may be configured to store, in the second non-volatile memory, the hash data and the backup version to be used to restore a state of the second firmware program to the normal state.

According to an embodiment of the disclosure, the at least one first processor may be configured to, based on the state of the second firmware program being identified as the normal state, transmit, to the control circuitry, the command and version information indicating a version of the second firmware program being stored in the first non-volatile memory. The control circuitry may be configured to store, in the second non-volatile memory, the version information and the backup version to be used to restore a state of the second firmware program.

According to an embodiment of the disclosure, the command may be a first command. The at least one first processor may be configured to, based on a state of the second firmware program being identified as the normal state, transmit, to the control circuitry, a second command and first version information indicating a first version of the second firmware program being stored in the first non-volatile memory. The control circuitry may be configured to, based on receiving the second command and the first version information, obtain, from the second non-volatile memory, second version information indicating a second version of data being stored in the second non-volatile memory. The control circuitry may be configured to, based on determination that the second version is prior to the first version, transmit, to the at least one first processor, a response indicating the determination. The at least one first processor may be configured to, based on receiving the response, transmit, to the control circuitry, the first command.

According to an embodiment of the disclosure, the response may be a first response. The control circuitry may be configured to, based on receiving the second command and the first version information, determine whether the data is stored in the second non-volatile memory in accordance with accessing the second non-volatile memory. The control circuitry may be configured to, based on determination that the data is not stored in the second non-volatile memory, transmit, to the at least on first processor, a second response indicating the determination. The at least one first processor may be configured to, based on receiving the second response, transmit, to the control circuitry, the first command.

According to an embodiment of the disclosure, the response may be a first response. The control circuitry may be configured to, based on determination that the second version is not prior to the first version, transmit, to the at least one first processor, a third response indicating the determination. The at least one first processor may be configured to, based on receiving the third response, refrain from transmitting the first command to the control circuitry.

According to an embodiment of the disclosure, the control circuitry may be configured to, based on receiving the second command, obtain, from the second non-volatile memory, the data and second hash data indicating a second hash value for validating the data being stored in the second non-volatile memory. The control circuitry may be configured to, using the data, obtain third hash data indicating a third hash value corresponding to the data. The control circuitry may be configured to, based on determination that the second hash value is identical to the third hash value, transmit, to the at least one first processor, the response.

As described above, an electronic device (e.g., the electronic device 100) may comprise a main circuit board (e.g., the main circuit board 200). The electronic device may comprise integrated circuitry (e.g., the integrated circuitry 205), mounted on the main circuit board. The integrated circuitry may comprise at least one first processor (e.g., the at least one first processor 210), and a second processor (e.g., the second processor 220). The electronic device may comprise first non-volatile memory (e.g., the first memory 230), mounted on the main circuit board, comprising one or more storage media. The one or more storage media may store a first firmware program configured to be executed by the at least one first processor individually or collectively for performing a booting-up of the electronic device, and a second firmware program, configured to be executed by the second processor, for providing at least a portion of a secure function in accordance with a command of the at least one first processor. The electronic device may comprise second non-volatile memory (e.g., the second memory 250), mounted on the main circuit board, comprising one or more storage media. The electronic device may comprise control circuitry (e.g., the control circuitry 240), mounted on the main circuit board, electrically connected to the at least one first processor, the first non-volatile memory, and the second non-volatile memory. The first firmware program may include instructions to cause the electronic device to, based on a start of the booting-up, execute the first firmware program. The first firmware program may include instructions to cause the electronic device to identify, using the first firmware program, a state of the second firmware program that is executed by the second processor based on the start of the booting-up of the electronic device. The first firmware program may include instructions to cause the electronic device to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the first non-volatile memory.

As described above, a method executed in an electronic device (e.g., the electronic device 100) having a main circuit board, integrated circuitry, mounted on the main circuit board, first non-volatile memory, mounted on the main circuit board, comprising one or more storage media, second non-volatile memory, mounted on the main circuit board, comprising one or more storage media, and control circuitry, mounted on the main circuit board, electrically connected to the at least one first processor, the first memory, and the second memory, may comprise executing a first firmware program based on a start of a booting-up of the electronic device. The integrated circuitry may comprise at least one first processor and a second processor. The one or more storage media included in the first non-volatile memory may store a first firmware program configured to be executed by the at least one first processor individually or collectively for performing the booting-up of the electronic device, and a second firmware program, configured to be executed by the second processor, for providing at least a portion of a secure function in accordance with a command of the at least one first processor. The method may comprise, based on the start of the booting-up of the electronic device, executing the first firmware program. The method may comprise identifying, using the first firmware program, a state of the second firmware program that is executed by the second processor based on the start of the booting-up of the electronic device. The method may comprise, based on the state of the second firmware program being identified as an abnormal state, transmitting, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the second non-volatile memory.

As described above, in a non-transitory computer readable storage medium comprising one or more programs, the one or more programs, when executed by an electronic device (e.g., the electronic device 100) having a main circuit board, integrated circuitry, mounted on the main circuit board, first non-volatile memory, mounted on the main circuit board, comprising one or more storage media, second non-volatile memory, mounted on the main circuit board, comprising one or more storage media, and control circuitry, mounted on the main circuit board, electrically connected to the at least one first processor, the first memory, and the second memory, may include instructions that cause the electronic device to execute a first firmware program based on a start of a booting-up of the electronic device. The integrated circuitry may comprise at least one first processor and a second processor. The one or more storage media included in the first non-volatile memory may store a first firmware program configured to be executed by the at least one first processor individually or collectively for performing the booting-up of the electronic device, and a second firmware program, configured to be executed by the second processor, for providing at least a portion of a secure function in accordance with a command of the at least one first processor. The one or more programs may include instructions, when executed by the electronic device, that cause the electronic device to, based on the start of the booting-up of the electronic device, execute the first firmware program. The one or more programs may include instructions, when executed by the electronic device, that cause the electronic device to, identify, using the first firmware program, a state of the second firmware program that is executed by the second processor based on the start of the booting-up of the electronic device. The one or more programs may include instructions, when executed by the electronic device, that cause the electronic device to, based on the state of the second firmware program being identified as an abnormal state, transmit, to the control circuitry, a command. The control circuitry may be configured to, based on the command received from the at least one first processor, obtain, from the second non-volatile memory, a backup version of the second firmware program which was backed up when the state of the second firmware program is identified as a normal state. The control circuitry may be configured to replace, with the backup version, at least a portion of the second firmware program stored in the second non-volatile memory.

The effects that can be obtained from the disclosure are not limited to those described above, and any other effects not mentioned herein will be clearly understood by those having ordinary knowledge in the art to which the disclosure belongs, from the following description.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium, such as a hard disk, floppy disk, and magnetic tape, optical recording medium such as compact disc read only memory (CD-ROM) and digital versatile disc (DVD), magneto-optical medium, such as a floptical disk, and those configured to store program instructions, including read only memory (ROM), random access memory (RAM), flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments of the disclosure, and those equivalent to the scope of the claims are in the scope of the claims described later. According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a main circuit board;
integrated circuitry, mounted on the main circuit board, comprising:
at least one first processor, and
a second processor;
first non-volatile memory, mounted on the main circuit board, comprising one or more storage media storing:
a first firmware program configured to be executed by the at least one first processor individually or collectively for performing a booting-up of the electronic device, and
a second firmware program, configured to be executed by the second processor, for providing at least a portion of a secure function in accordance with a command of the at least one first processor;
second non-volatile memory, mounted on the main circuit board, comprising one or more storage media; and
control circuitry, mounted on the main circuit board, electrically connected to the at least one first processor, the first non-volatile memory, and the second non-volatile memory,
wherein the at least one first processor is configured to:
based on a start of the booting-up of the electronic device, execute the first firmware program,
identify, using the first firmware program, a state of the second firmware program that is executed by the second processor based on the start of the booting-up of the electronic device, and
based on the state of the second firmware program being identified as an abnormal state, transmit, to the control circuitry, a command, and
wherein the control circuitry is configured to:
based on the command received from the at least one first processor, obtain, from the second non-volatile memory, a backup version of the second firmware program which was backed up when the state of the second firmware program is identified as a normal state, and
replace, with the backup version, at least a portion of the second firmware program stored in the first non-volatile memory.

2. The electronic device of claim 1,
wherein the at least one first processor is further configured to:
based on transmitting the command, change a power state of the integrated circuitry to a power-off state, and
wherein the control circuitry is further configured to:
based on the command received from the at least one first processor, identify the power state of the integrated circuitry, and
based on the power state of the integrated circuitry being identified as the power-off state, access the first non-volatile memory for replacing the at least a portion of the second firmware program with the backup version.

3. The electronic device of claim 2, wherein the power-off state includes a G3 state.

4. The electronic device of claim 1, wherein the first firmware program includes a basic input-output system (BIOS).

5. The electronic device of claim 1, wherein the at least one first processor is further configured to:
after the at least a portion of the second firmware program is replaced with the backup version, based on a start of the booting-up of the electronic device, execute the first firmware program, and
identify, using the first firmware program, as the normal state, a state of the second firmware program in accordance with a restoration based on the backup version.

6. The electronic device of claim 1,
wherein the integrated circuitry further comprises a register used to identify the state of the second firmware program, and
wherein the at least one first processor is further configured to:
when identifying the state of the second firmware program using the first firmware program, based on accessing the register, identify a flag indicating the state of the second firmware program, and
based on the flag being identified as an error flag, identify the state of the second firmware program as the abnormal state.

7. The electronic device of claim 1, wherein the control circuitry is further configured to:
based on the command received from the at least one first processor, obtain, from the second non-volatile memory, the backup version and first hash data indicating a first hash value,
using the backup version, obtain second hash data indicating a second hash value corresponding to the backup version, and
based on determination that the first hash value is identical to the second hash value, access the first non-volatile memory for replacing the at least a portion of the second firmware program with the backup version.

8. The electronic device of claim 1,
wherein the at least one first processor is further configured to:
based on the state of the second firmware program being identified as the abnormal state, transmit, to the control circuitry, the command and offset information, and
wherein the control circuitry is further configured to:
using the offset information, identify a part of the second firmware program to be restored, and
based on accessing the first non-volatile memory, replace, with a first portion of the backup version corresponding to the part of the second firmware program, a second portion of the second firmware program corresponding to the part of the second firmware program.

9. The electronic device of claim 1,
wherein the command is a first command,
wherein the at least one first processor is further configured to:
based on the state of the second firmware program being identified as the abnormal state, transmit, to the control circuitry, a second command,
wherein the control circuitry is further configured to:
based on receiving the second command, determine whether the backup version usable for restoring the state of the second firmware program is stored in the second non-volatile memory using a hash value, and
based on determination that the backup version usable for restoring the state of the second firmware program is stored in the second non-volatile memory, transmit, to the at least one first processor, a response indicating the determination, and
wherein the at least one first processor is further configured to:
based on receiving the response, transmit, to the control circuitry, the first command.

10. The electronic device of claim 9, wherein the control circuitry is further configured to:
based on receiving the second command, obtain, from the second non-volatile memory, the backup version and third hash data indicating a third hash value for determining whether the backup version usable for restoring the state of the second firmware program is stored in the second non-volatile memory,
using the backup version, obtain fourth hash data indicating a fourth hash value corresponding to the backup version, and
based on determination that the third hash value is identical to the fourth hash value, determine that the backup version is usable for restoring the state of the second firmware program.

11. The electronic device of claim 1,
wherein the control circuitry includes a third processor for executing a third firmware program, and
wherein the third firmware program is used to monitor a power state of the integrated circuitry and to update a firmware program of the electronic device.

12. An electronic device comprising:
a main circuit board;
integrated circuitry, mounted on the main circuit board, comprising:
at least one first processor, and
a second processor;
first non-volatile memory, mounted on the main circuit board, comprising one or more storage media storing:
a first firmware program configured to be executed by the at least one first processor individually or collectively for performing a booting-up of the electronic device, and
a second firmware program, configured to be executed by the second processor, for providing at least a portion of a secure function in accordance with a command of the at least one first processor;
second non-volatile memory, mounted on the main circuit board, comprising one or more storage media; and
control circuitry, mounted on the main circuit board, electrically connected to the at least one first processor, the first non-volatile memory, and the second non-volatile memory,
wherein the at least one first processor is configured to:
based on a start of a booting-up of the electronic device, execute the first firmware program,
identify, using the first firmware program, a state of the second firmware program that is executed by the second processor based on the start of the booting-up of the electronic device, and
based on the state of the second firmware program being identified as a normal state, transmit, to the control circuitry, a command, and
wherein the control circuitry is configured to:
based on the command received from the at least one first processor, obtain, from the first non-volatile memory, a backup version of the second firmware program being identified as the normal state, and
store, in the second non-volatile memory, the backup version to be used to restore a state of the second firmware program which will be identified as an abnormal state to the normal state.

13. The electronic device of claim 12,
wherein the at least one first processor is further configured to:
based on transmitting the command, change a power state of the integrated circuitry to a power-off state, and
wherein the control circuitry is further configured to:
based on the command received from the at least one first processor, identify the power state of the integrated circuitry, and
based on the power state of the integrated circuitry being identified as the power-off state, access the first non-volatile memory for obtaining the backup version.

14. The electronic device of claim 12,
wherein the integrated circuitry further comprises a register used to identify a state of the second firmware program, and
wherein the at least one first processor is further configured to:
when identifying the state of the second firmware program using the first firmware program, based on accessing the register, identify a flag indicating the state of the second firmware program, and
based on the flag being identified as a predetermined flag, identify the state of the second firmware program as the normal state.

15. The electronic device of claim 12, wherein the control circuitry is further configured to:
based on obtaining the backup version, obtain hash data corresponding to the backup version, and
store, in the second non-volatile memory, the hash data and the backup version to be used to restore a state of the second firmware program to the normal state.

16. The electronic device of claim 12,
wherein the at least one first processor is further configured to:
based on the state of the second firmware program being identified as the normal state, transmit, to the control circuitry, the command and version information indicating a version of the second firmware program being stored in the first non-volatile memory, and
wherein the control circuitry is further configured to:
store, in the second non-volatile memory, the version information and the backup version to be used to restore a state of the second firmware program.

17. The electronic device of claim 12,
wherein the command is a first command,
wherein the at least one first processor is further configured to:
based on a state of the second firmware program being identified as the normal state, transmit, to the control circuitry, a second command and first version information indicating a first version of the second firmware program being stored in the first non-volatile memory,
wherein the control circuitry is further configured to:
based on receiving the second command and the first version information, obtain, from the second non-volatile memory, second version information indicating a second version of data being stored in the second non-volatile memory, and
based on determination that the second version is prior to the first version, transmit, to the at least one first processor, a response indicating the determination, and
wherein the at least one first processor is further configured to:
based on receiving the response, transmit, to the control circuitry, the first command.

18. The electronic device of claim 17,
wherein the response is a first response,
wherein the control circuitry is further configured to:
based on receiving the second command and the first version information, determine whether the data is stored in the second non-volatile memory in accordance with accessing the second non-volatile memory, and
based on determination that the data is not stored in the second non-volatile memory, transmit, to the at least on first processor, a second response indicating the determination, and
wherein the at least one first processor is further configured to:
based on receiving the second response, transmit, to the control circuitry, the first command.

19. The electronic device of claim 17,
wherein the response is a first response,
wherein the control circuitry is further configured to:
based on determination that the second version is not prior to the first version, transmit, to the at least one first processor, a third response indicating the determination, and
wherein the at least one first processor is further configured to:
based on receiving the third response, refrain from transmitting the first command to the control circuitry.

20. The electronic device of claim 17, wherein the control circuitry is further configured to:
based on receiving the second command, obtain, from the second non-volatile memory, the data and second hash data indicating a second hash value for validating the data being stored in the second non-volatile memory,
using the data, obtain third hash data indicating a third hash value corresponding to the data, and
based on determination that the second hash value is identical to the third hash value, transmit, to the at least one first processor, the response.
